(19) United States
(12) Patent Application Publication
(10) Pub. No.: US 2012/0188075 A1
(43) Pub. Date: Jul. 26, 2012

(54) REMOTELY ACTIVATED EXTERIOR INTERMITTENT ALERT LIGHTING SYSTEM

(76) Inventor: Conrad P. Klusmeier, II, Cape Girardeau, MO (US)

(21) Appl. No.: 13/356,353

(22) Filed: Jan. 23, 2012

Related U.S. Application Data
(60) Provisional application No. 61/461,799, filed on Jan. 24, 2011.

(51) Int. Cl. G08B 1/08

(52) U.S. Cl. 340/539.14

(57) ABSTRACT

A remotely activated exterior intermittent alert lighting system has a case upon a base and receives power from utility service. Upon the case, a light assembly receives power from internal wiring controlled by a processor receptive to short range radio. The processor receives ON and OFF signals through an antenna that receives a signal from a nearby radio transmitter. Upon detecting an ON signal, the processor closes circuits to deliver power to a lighting assembly. The lighting assembly then flashes its elements by the processor or a lighting assembly component. Upon detecting an OFF signal, the processor deactivates the lighting assembly. The lighting assembly typically operates upon direct current provided from a transformer connected to the utility service. Alternatively, the system operates upon battery power.

### CROSS-REFERENCE TO RELATED APPLICATION

This non-provisional application claims priority to the pending provisional application 61/461,799 filed on Jan. 24, 2011 which is owned by the same inventor.

### BACKGROUND OF THE INVENTION

The remotely activated exterior intermittent alert lighting system generally relates to warning lights and more specifically to command activated exterior flashing lights. The invention relates to lighting placed upon the exterior of a home but activated from within the home.

People live in many locations. Some live in urban cities, others live in suburbs, and some reside in rural areas. Cities generally have abundant street lighting and marking of addresses upon buildings. In the suburbs, buildings have addresses upon them and residential streets have some street lighting. Rural areas though have residences spaced widely apart, often in miles. Rural residences may lack a house number upon the house but rather have the number upon a mailbox at a nearby road. In more rural areas, such as upstate Vermont, the mailboxes lack numbers. Add nightfall or inclement weather and locating houses in some suburbs and most rural areas requires skill, and in some cases luck. Some rural residences have a flagpole or other signal of their location. However, nightfall and inclement weather can obscure those residence indicating devices.

People still live in rural houses. As with other people and families, emergencies happen from time to time. The emergencies may require summoning first responders to a residence. Rural first responders have familiarity with their locality, at least the roads, however some houses remain set back from the road and often remain concealed by terrain or vegetation. Reports have arrived of first responders making an approach to an address at a slow rate of speed to find the address. Meanwhile, minutes of the golden hour for rescue tick away.

Even after a 911 call or other summons has gone to first responders, people may remain within a building. In the event of a crime against person in progress, a victim may be reluctant to leave a building, such as a house or a barn, to get the attention of the first responders. People may leave lights on in a building to guide first responders but subject to concealment by terrain, vegetation, nightfall, and inclement weather. When seconds count, first responders need to find a rural building as readily as an urban residence.

### DESCRIPTION OF THE PRIOR ART

Over the years, people have used various signaling devices to indicate distress of a person near a building. As mentioned above, people have used inverted flags on flagpoles, left lights on in a residence, and honked horns of vehicles and equipment to get the attention of first responders whether police, fire, or ambulance. The prior art includes various alarms device with exterior horns or bells. Some buildings have an exterior mounted bell that signals an elevator emergency that occurs deep inside a building. Though generating sound, the horns and bells mounted on buildings have limited effectiveness in rural areas. Rural buildings, often being far from a road, likely do not have passersby that may hear a horn or a bell. First responders in a vehicle with its own siren engaged may not hear a horn or a bell from a building.

The prior art also includes various emergency lighting systems. Other flashing light alert systems assist in identifying a specific residence when in need of a first responder. However those systems have a bulb that replaces the standard incandescent bulb with a bulb with integral flasher circuitry. The prior art flasher bulb activates when a person flips a standard light switch quickly upwardly twice triggering the flasher circuitry to operate and the light to begin flashing. The issue with the prior art flasher bulb is its use as an ordinary light fixture most of the time, not its use as an emergency alarm. Over time, people forget the signaling capability of the flasher bulb.

To signal first responders and to overcome people's forgetfulness, a need exists for a specific emergency alert device that is known as an emergency light at all times, viewable by first responders at a distance in inclement weather and at night, and that upon an emergency, people remember to use readily.

The present invention overcomes the disadvantages of the prior art and provides an remotely activated exterior intermittent alert lighting system that people know of its emergency function and that people can activate at a moment's notice. The present invention has a dedicated power source, an exterior mounting visible to first responders, strong light signal, and radio command operation by a person for when an emergency occurs.

### SUMMARY OF THE INVENTION

Generally, the remotely activated exterior intermittent alert lighting system has a case upon a base and receives power from utility service. Upon the case, a light assembly receives power from internal wiring regulated by a processor under short range radio control. The processor receives ON and OFF signals through an antenna that receives a radio signal from a nearby radio transmitter. Upon detecting an ON signal, the processor closes circuits to deliver power to a lighting assembly upon the front of the case. The lighting assembly then flashes its elements in an intermittent pattern regulated by the processor or alternatively by a lighting assembly component. Upon detecting an OFF signal, the processor ceases delivery of power to the lighting assembly, deactivating it. The lighting assembly typically operates upon direct current provided from a transformer connected to the utility service.

A flashing warning device like the remotely activated exterior intermittent alert lighting system alerts first responders to a specific residence when triggered by a person in an emergency situation in or near the residence. When an emergency occurs, a person activates the invention by a remote activation switch or by moving a switch located on the invention. The invention allows for mounting upon an exterior wall of a residence or in the window area of a residence. Upon activation, the invention flashes a light rapidly and strongly to alert passersby and first responders as to which residence needs their assistance. More particularly, the invention includes alternating flashing red and blue lights familiar to first responders. The invention makes the home that has activated the invention stand out from neighboring homes and from the terrain.

After a person calls 911 or other emergency number, can first responders find the person? Persons in rural areas or in homes concealed by terrain or vegetation increase the difficulty for first responders to find the person. First responders can approach the general area of a person, usually to within the range of a cell phone tower or nearest road intersection. Reaching a person behind a hill or concealed by trees can add minutes to a response time when the person can ill afford loss of time. The present invention removes the need for a person, or relative of the person, to stand outdoors at night or in bad weather to get the attention of first responders. First responders can see the invention, when activated, from great distances which allows them to approach the summoning person without delay.

There has thus been outlined, rather broadly, the more important features of the invention in order that the detailed description thereof that follows may be better understood and that the present contribution to the art may be better appreciated. The present invention also includes Fresnel like lens shaping in the cover, battery power, ON and OFF buttons upon a transmitter, and window mounting hardware. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, the phraseology and terminology employed herein are for the purpose of description and should not be regarded as limiting.

One object of the present invention is to provide a remotely activated exterior intermittent alert lighting system that activates upon remote command.

Another object is to provide such a remotely activated exterior intermittent alert lighting system that allows for mounting upon the exterior of a residence.

Another object is to provide such a remotely activated exterior intermittent alert lighting system that operates upon utility service or battery power.

Another object is to provide such a remotely activated exterior intermittent alert lighting system that has a minimum of components for ready manufacturing and later installation by unskilled labor.

Another object is to provide such a remotely activated exterior intermittent alert lighting system that has a low cost of manufacturing so the purchasing homeowners, decorators, business establishments, and organizations can readily buy the remotely activated exterior intermittent alert lighting system through stores and supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 provides a front view of the invention installed on a structure and the surrounding area;

FIG. 2 shows a front view of the invention;

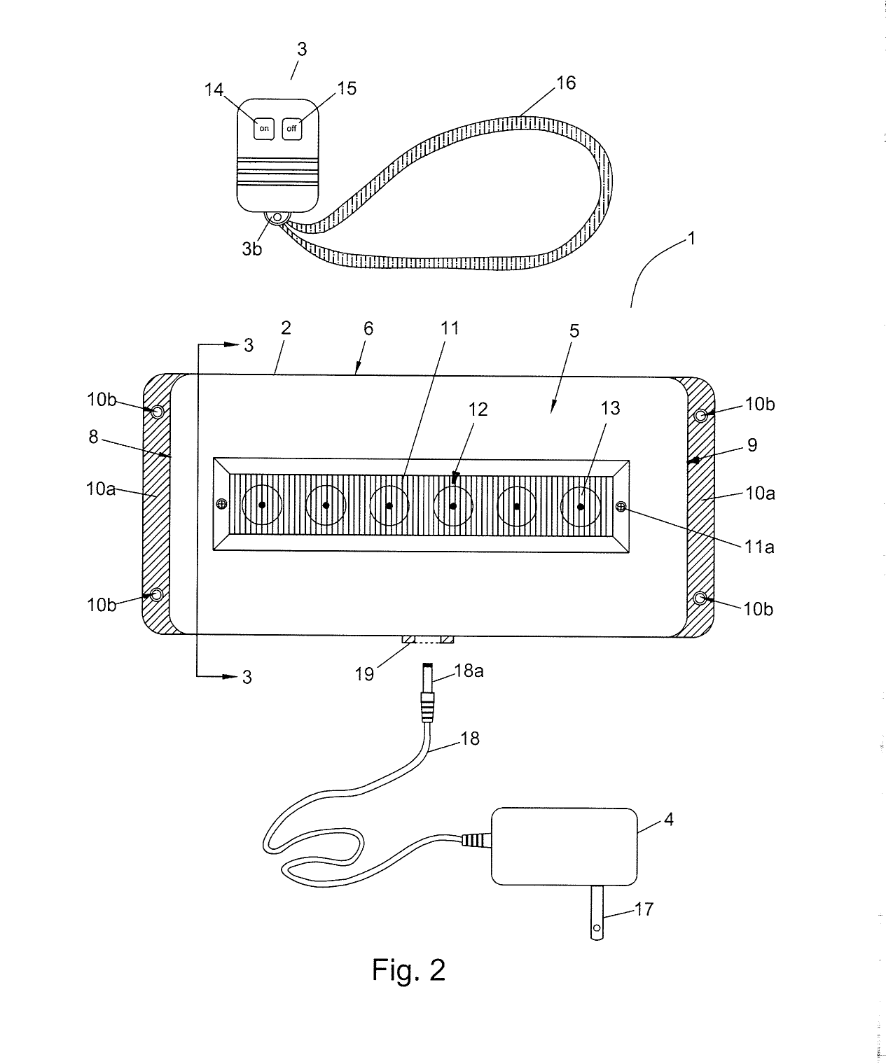

FIG. 3 describes a sectional view of the invention;

FIG. 4 illustrates a bottom view of the invention;

FIG. 5 illustrates a top view of the invention, opposite FIG. 4;

FIG. 6 shows a side view of the invention;

FIG. 7 shows another side view of the invention, opposite FIG. 6;

FIG. 8 describes a front view of installation of the invention upon an exterior wall of a structure;

FIG. 9 describes a perspective view of the invention installed upon a window in a structure; and,

FIG. 10 shows a perspective view of a hanger of the invention.

The same reference numerals refer to the same parts throughout the various figures.

### DESCRIPTION OF THE PREFERRED EMBODIMENT

The present art overcomes the prior art limitations by providing a remotely activated exterior intermittent alert lighting system. Self contained, the present invention flashes light rapidly outwardly to alert others of an emergency need at a location. The present invention completely houses the flashing light unit, power supply, and all components for alerting others of the emergency. When an emergency occurs, a user, or nearby relative or friend, presses the manual switch located on the side of the device or preferably activates the device through a remote alert switch, or the transmitter, carried on the user or in the user's residence. Upon activation, the lights begin to flash outwardly rapidly in a predetermined pattern that would get the attention of bystanders or first responders approaching the residence.

The flashing light mounts to the front of a residence, often outside of the self-contained boxed unit that can be mounted to the residence through tabs or placed at other suitable locations. The manual switch is located on the side of the boxed unit. The manual switch allows the battery unit to supply power to the flashing unit to initiate the flashing light pattern when commanded. Another electronic switch, located within the boxed unit, allows the unit to begin flashing. The activation of the internal electronic switch occurs through a remote button, located inside the residence of a user or preferably worn upon the user most likely to need assistance.

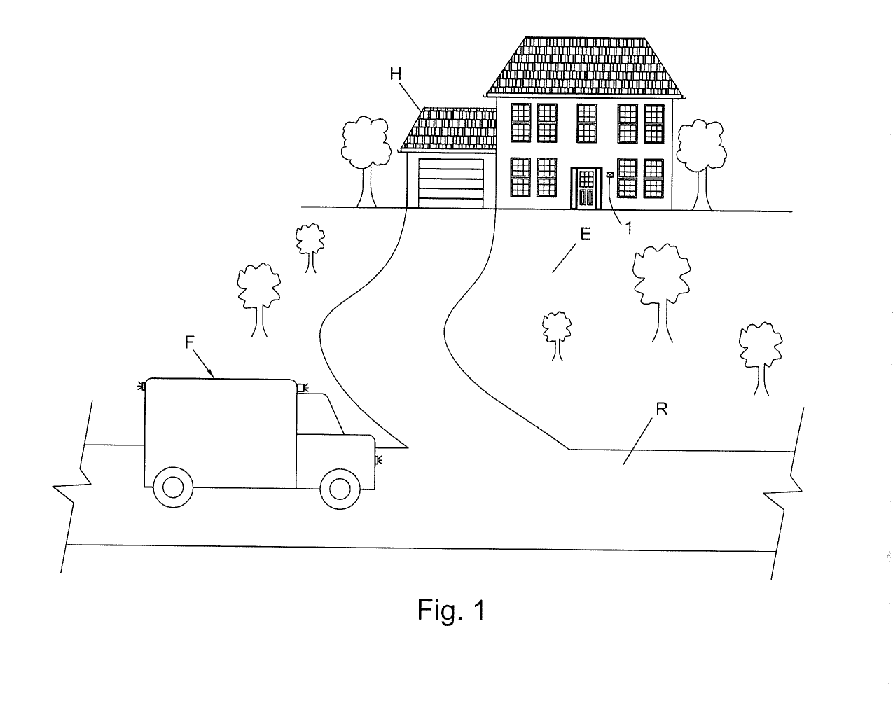

Turning to FIG. 1, the present invention 1 installs upon a home H as later described. As shown, the home is part of wooded terrain E that makes for pleasant living, often in a rural setting. The home has a drive of some length to the nearest road R. As mentioned above wooded terrain and hills may block viewing of the home from the road. First responders F will take the road when summoned to the home H by a person in distress in the home or on the grounds E. The invention 1 flashing when activated gets the attention of approaching first responders.

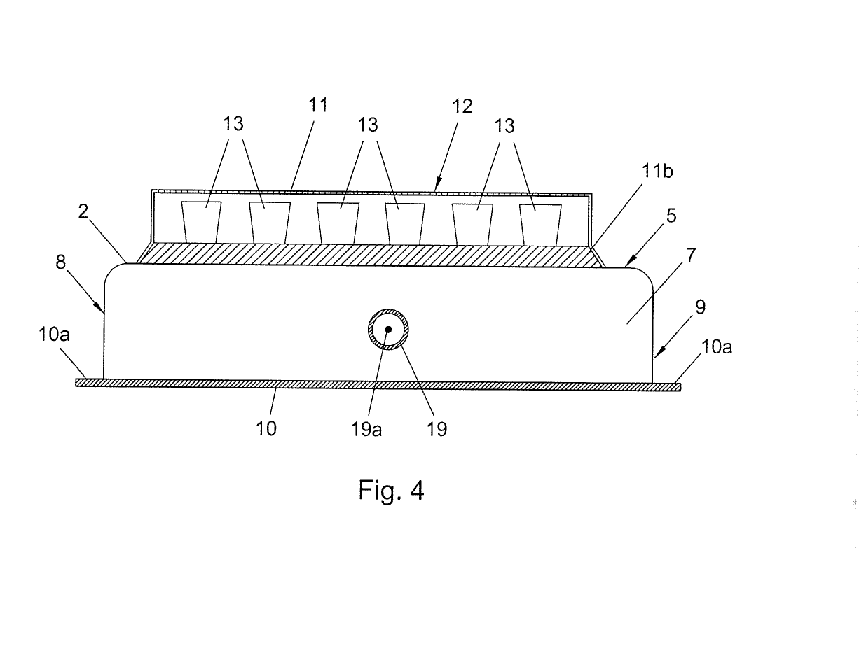

The invention 1 has a casing 2, generally rectangular, a transmitter 3, and a power supply, preferably utility service, here shown as a transformer 4. The casing has a generally rectangular shape with a front 5 and an opposite base, later shown in FIG. 4. Perpendicular to the front, mutually parallel and spaced apart, a top 6 and an opposite bottom 7 extend rearward from the front. Perpendicular to the front and to the top and the bottom, a left side 8 and a right side 9 also have a mutually parallel and spaced apart arrangement. As shown in this figure, a base 10 extends outwardly from the left side 8 and the right side 9 with two spaced apart flanges 10a integral with the remainder of the base. Each flange has two spaced apart apertures 10b that receive fasteners for installation of the base to a home as later described.

Outwardly from the front and opposite the top, bottom, left side, and right side, the invention has a light assembly 11 here shown extending into the foreground. The light assembly secures to the front 5 using at least two fasteners as at 11a. The light assembly includes a cover 12 and a plurality of elements 13. The cover includes a Fresnel lens like surface that partially aims the light emitted by the elements.

Worn or carried by a user, the transmitter 3 includes an ON button 14 and an OFF button 15 in communication with a low power radio frequency transmitter. The ON button activates transmission of a radio signal to the case 2 that initiates flashing of the elements 13 while the OFF button activates transmission of a radio signal to the case that stops the flashing of the elements 13. Though shown as of similar size, the Applicant foresees an alternate embodiment where the ON button has a larger size or shape than the OFF button. The transmitter also includes a lanyard 16 secured to a tab 3b upon the body of the transmitter. In an alternate embodiment, the transmitter includes a sound generator or vibration unit that discretely indicates to the user that the invention has activated. The sound generator or vibration unit triggers upon the user pressing button 14. In a further alternate embodiment, the transmitter receives a return signal from the processor or the light assembly which triggers a sound generator or vibration unit that discretely indicates to the user that the invention has activated.

The preferred embodiment of the invention operates upon utility service provided by the circuitry of the user's residence. Utility service, generally at 120 volts, 60 Hz of alternating current, exceeds the power requirements of the light assembly 11. The invention includes a transformer 4 that steps down and rectifies the household current into approximately 12 volt direct current of approximately 500 milliamps. The transformer includes two prongs 17 plug into a household outlet and a cord 18 extending from the transformer and ending in a female barrel socket 18a. As later described, the barrel socket delivers the direct current to the lighting assembly.

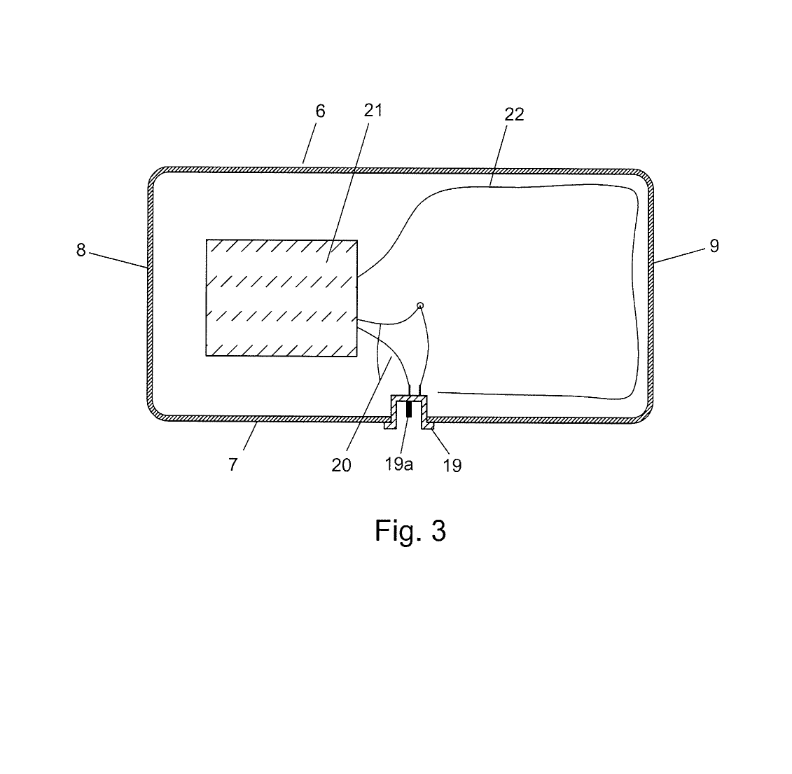

Turning to FIG. 3, this figure shows a sectional view lengthwise through the invention where the barrel socket connects to a male socket 19 in the bottom 7 of the case 2. The male socket has a generally centered location in the bottom and the presence of the male socket denotes this portion of the case as the bottom. Placing the socket in the bottom 7 protects the male socket and its connection with the barrel socket 18a from the weather. The bottom location of the socket 19 also makes the cord appear more aesthetically pleasing upon installation of the invention upon a residence. The male socket 19 includes a pin 19a of a small diameter that fits snugly within the barrel socket 18a. The snug connection of the barrel socket 18a into the male socket 19 delivers power from the transformer to the rest of the invention.

The male socket delivers power through wiring 20 in communication to a processor 21. The processor also has an antenna 22 that receives the signals from the transmitter 3. The antenna is generally an elongated wire bent to fit within the case but having sufficient length to receive the transmitter signals from a suitable range. Upon receipt of a signal, the antenna delivers the signal to the processor. The processor determines whether the signal is from the ON button to activate the lighting assembly or whether the signal is from the OFF button to deactivate the lighting assembly. Upon receipt of a signal from the ON button, the processor then closes appropriate internal circuits and delivers power to the lighting assembly, turning it on and flashing the elements intermittently as directed by the processor. Upon receipt of a signal from the OFF button, the processor opens appropriate internal circuits, thus interrupting power to the lighting assembly previously supplied from an ON button signal and turning off the light assembly. If a user presses the OFF button without a preceding ON button signal, the processor retains the appropriate internal circuits in their open state.

In an alternate embodiment, the processor has its antenna 22 that receives the signals from the transmitter 3 and upon receipt of a signal, delivers it to the processor. The processor determines whether the signal is from the ON button to activate the lighting assembly or whether the signal is from the OFF button to deactivate the lighting assembly. Upon receipt of a signal from the ON button, the processor then closes appropriate internal circuits and delivers power to the lighting assembly, turning it on so that internal circuitry in the lighting assembly causes the elements to flash or to illuminate intermittently. Upon receipt of a signal from the OFF button, the processor opens appropriate internal circuits, thus interrupting power to the lighting assembly, turning it off. If a user presses the OFF button without a preceding ON button signal, the processor retains the appropriate internal circuits in their open state. In the preferred embodiment, the processor directs the light elements to flash while in the alternate embodiment, the light assembly includes integral circuitry to flash the light elements.

Then FIG. 4 provides a bottom view of the invention 1, typically seen before installation and upon connection or disconnection of the barrel socket 18a from the socket 19. The socket has within it the pin 19a as previously described. The case 2 connects to one face of the base 10 and the base has its flanges 10a extending outwardly from the case, generally symmetrically. The case shows its bottom 7 in this view with the left side 8 and the right side 9 spaced apart and extending away from the bottom as previously described. The left side and the right side have a generally rounded joint to the bottom and the front. Upon the front 5 of the case, the invention has the lighting assembly 11 attached. The lighting assembly has its transparent lens, or cover 12 in a generally rectangular shape, parallel to the length of the invention, that is, parallel to the bottom 7. Beneath the cover 12, the lighting assembly has a plurality of elements 13, typically of light emitting diodes visible to at least one mile in at least two colors, upon a backer 11b. The lighting assembly is manufactured by Cree, Inc. of Durham, N.C. among other suppliers. Preferably, the lighting assembly has six elements, each controlled by the processor for illumination, color, and flashing. In an alternate embodiment, the lighting assembly includes its own internal circuitry that flashes the elements in an alternating manner.

The lighting assembly, as made by Cree, began as an automotive accessory operating upon 12 volts, produced by a vehicle electrical system. The present invention though steps down household electrical service, typically 120 volts for application in a residential setting. Though most have considered the lighting assembly in automotive application, the Applicant has adapted the lighting assembly to fill an unmet need of identifying a house with a person inside in an emergency state.

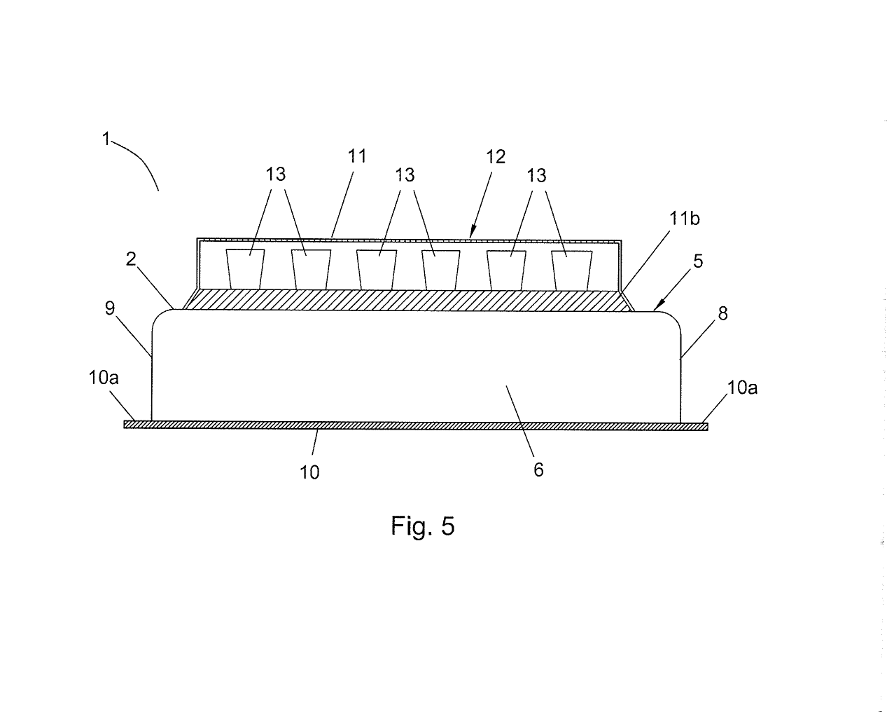

Opposite FIG. 4, FIG. 5 provides a top view of the invention. The top 6 of the case 2 is in the foreground in this view. Unlike the bottom 7, the top 6 lacks a socket as previously described. This view is generally seen during installation and when a person glances at the invention from time to time when installed.

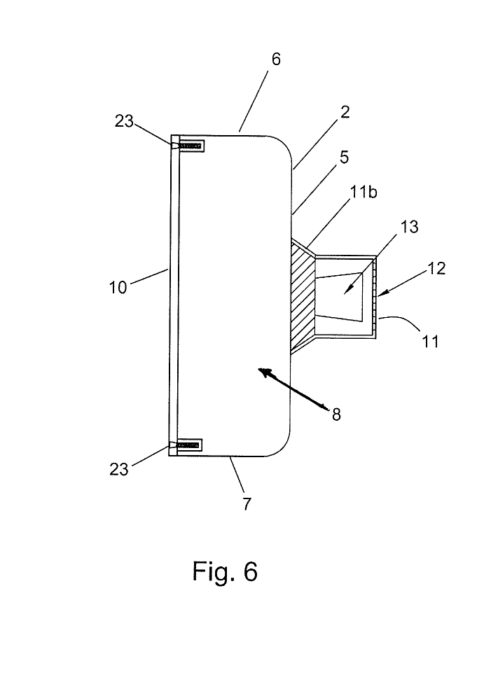

Turning the invention 1 again, FIG. 6 shows a side view of the case 2 as installed upon a building, not shown, towards the left. The case 2 connects to the base 10 as previously described and uses mechanical fasteners 23, such as screws, to make the connection. Alternate embodiments may utilize rivets, bayonet locks, or thermal welding to connect the case upon the base. Outwardly from the base, the case shows its left side 8 in the foreground and having the top 6 above and the bottom 7 below the left side. The left side and the right side merge into the front 5 in a rounded manner. The front is generally parallel to and spaced apart from the base 10. The lighting assembly 11 attaches to the front 5, in a generally centered manner. The backer 11b attaches through the apertures 11a as previously shown. From the backer, the elements 13 extend outwardly and opposite from the front. And, the cover 12 surrounds the elements as a group and extends outwardly from the backer.

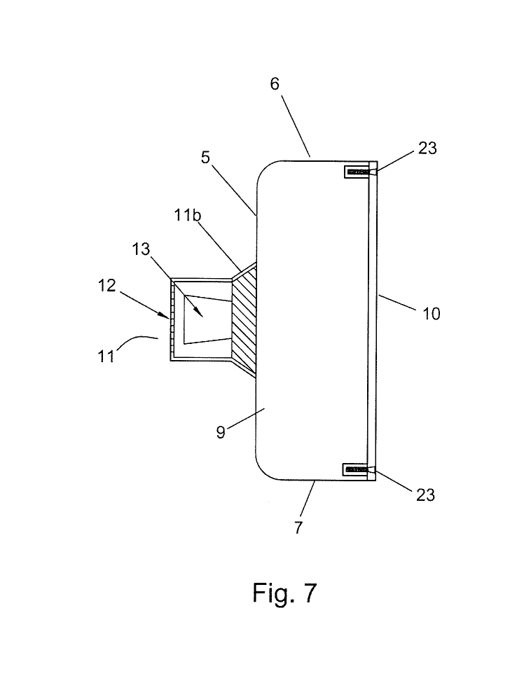

On the other side of the case, FIG. 7 provides an opposite side view of the installed case 2, towards the right in this view. The case 2 connects to the base 10 using the fasteners 23. The right side 9 appears in the foreground with the top above and the bottom below. And the lighting assembly 11 attaches to the front 5, opposite the base.

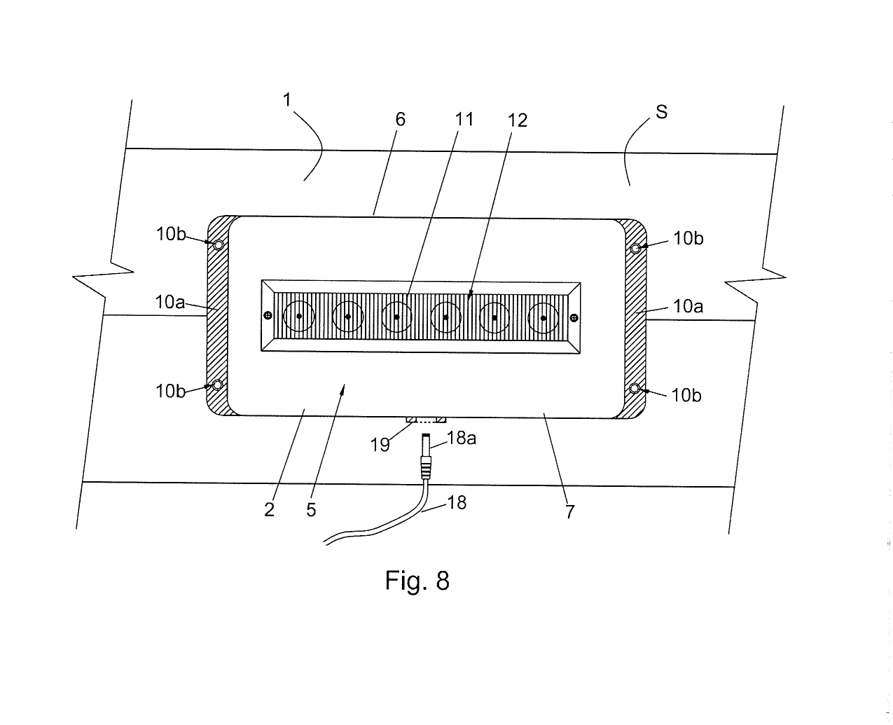

The present invention primarily mounts upon the exterior of a home H as in FIG. 8. The invention has a design suitable for mounting to a front porch or other location with some protection from the elements. The base 10 has its flanges 10a extending outwardly from the case 2. The flanges have their apertures 10b as shown that admit a screw, nail, or other fastener for mounting the invention 1 to an exterior wall of a home, as upon siding S. An installer may utilize commonly accepted mounting techniques to connect the base to the wall.

For best results in operation of the invention, a user should mount the invention with the cover 12 and light assembly 11 facing the anticipated direction of approaching first responders F, see FIG. 1. A user should mount the invention upon a home so that the cover and light avoid concealment and obstruction by vegetation, such as trees and shrubs, and terrain such as berms and hills. An installation with a clear line of sight assists the first responders when they approach during a time of need. A user should also install the invention in proximity of a power source, such as an exterior electrical outlet. The user then plugs the transformer 4—more particularly its prongs 17—into an electrical outlet and lastly inserts the barrel socket 18a into the male socket 19. The invention is thus fully powered and awaiting a signal from the transmitter 3 at a time of need.

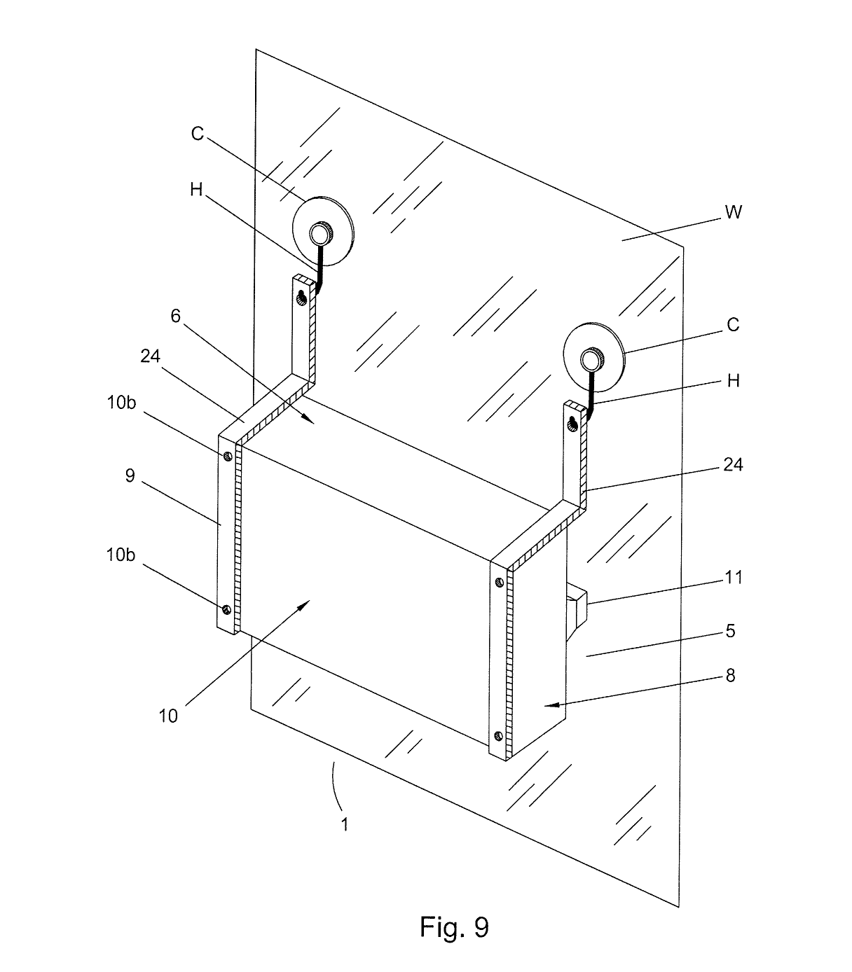

As an alternate mounting, FIG. 9 shows the invention 1 mounted upon two spaced apart hangers 24 upon a window W in a home H facing outwardly. Each hanger fits upon a hook H connected to a suction cup C. The hooks and the suction cups are commercially available through various supply outlets. As above, a user should mount the invention with the cover 12 and light assembly 11 facing the anticipated direction of approaching first responders but avoiding lines of sight with vegetation or terrain. A user should also install the invention in proximity of an exterior electrical outlet for plugging in the transformer N and then inserting the barrel socket 18a into the socket 19. The fully powered invention thus awaits a command from the transmitter 3 at a time of need.

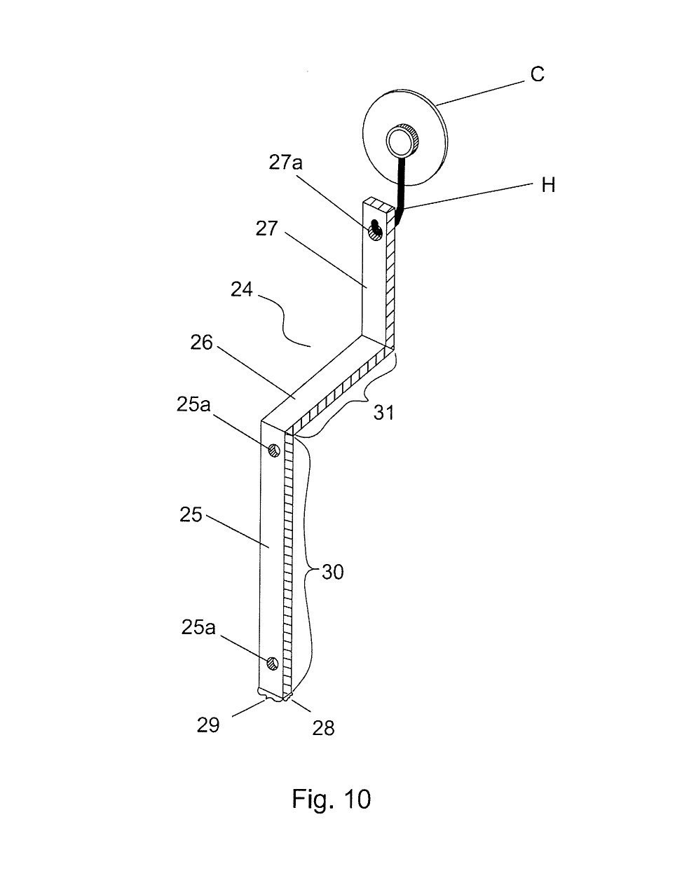

And FIG. 10 shows one of the hangers 24 separated from the base 10 of the invention 1. The hanger has a generally rotated S like shape with a first upright 25 connected on an end to a web 26 perpendicularly and a second upright 27 connected on its end to the web 26 perpendicularly and spaced apart from the first upright. The first upright and the second upright are spaced apart and mutually parallel. The web though is perpendicular to both uprights and offset both uprights. The first upright is generally narrow and elongated, with a thickness 28, a width 29, and a length 30 generally similar to the width of the base, that is, the length of either the left side or the right side. The thickness is of such amount to support the weight of the invention without shear failure of the web and upright joint. The first upright includes two spaced apart apertures 25a that match the apertures 10b in the flanges 10a and accept mechanical fasteners, such as bolts. The first upright has two opposite ends perpendicular to its length. Upon one end, the web 26 joins perpendicular to the first upright. The web has the same width 29 and thickness 28 as the first upright but less length. The web's length 31 is slightly more than the width of either side 8,9 and the lighting assembly 11 so that the web spaces the invention slightly away from a window W when installed, as in FIG. 9. The web also has two opposite ends perpendicular to its length. Opposite the first upright, the web joins to the second upright 27 where the second upright is perpendicular to the web but parallel to the first upright. The second upright extends in an opposite direction as the first upright as shown. The second upright also has the same thickness 28 and width 29 as the first upright and the web. The second upright though has its length shown less than the length 31 of the web. Away from the web, the second upright has its aperture 27a that admits a hook H. This aperture 27a is generally larger than the other apertures 25a in the hanger 24. The present invention preferably provides two hangers and related cups to mount the lighting assembly generally parallel to a window sill or the horizon when installed.

So, when a time of need, or emergency, arises, a user calls 911 himself, or a nearby relative or friend places the call. The user or other caller then explains the emergency to the 911 operator. After placing the call, the user grips the transmitter 3 and presses the left button 14. The left button causes the transmitter to emit a signal detected by the antenna 22 which then energizes the processor 21 and activates the lights 13 in the assembly 11. The lights then flash to attract the attention of approaching first responders.

The invention operates to allow a user to visibly indicate an emergency at a residential structure in a rural area to first responders at a distance of at least one mile. A user follows this method of utilizing a device as described above having intermittent illumination and activated by radio command from a separate hand held transmitter, installing the device upon an exterior surface of a residence visible to the first responders and connecting the device to utility service of the residence, when needed, triggering the device to illuminate upon a signal emitted by the transmitter when the user presses a button of the transmitter. Later the user may deactivate the device upon pressing another button of the transmitter.

The Applicant also provides notice flyers to users of the invention. The users distribute the flyers to neighbors, informing them of the presence of the invention and requesting the neighbors to act upon seeing the invention illuminate. A neighbor need merely call 911 or other emergency number upon seeing the invention flashing. As you can see through the drawings, this is a flashing warning device that will help assist emergency personnel or neighbor to the residence to render help to whomever is in need.

The Applicant notes that the light elements 13 have a strong brightness and thus gazing into the lights is discouraged. The present invention has its intended use for identifying a home, house, or other residence. The Applicant cautions users to avoid usage of the invention in an attempt to impersonate a public official, especially law enforcement and other first responders. Though designed to identify a home, house, or residence of a person in need, the present invention though makes no claim and no guarantee of any response time or improvement in response time of first responders.

In alternate embodiment, the base includes a panel of lesser width and length. The panel allows access within the case for placement and removal of at least one battery that provides power to the processor and lights in lieu of utility service. A person may use the transmitter to activate this battery powered embodiment or alternate press a switch installed upon the exterior of case, such as upon the right side, and wired to the processor.

From the aforementioned description, a remotely activated exterior intermittent alert lighting system has been described. The remotely activated exterior intermittent alert lighting system is uniquely capable of signaling approaching first responders of a user in need who has activated the invention remotely. The remotely activated exterior intermittent alert lighting system and its various components may be manufactured from many materials, including but not limited to, wood, steel, aluminum, polymers, nylon, polyvinyl chloride, high density polyethylene, polypropylene, ferrous and non-ferrous metals, their alloys, and composites. In an alternate embodiment, the plate joins to the base by welding along the edges in place of fasteners.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A system installed upon an exterior surface of a residential structure that visibly indicates an emergency therein, comprising:
a case having a base, a front opposite said base, two mutually parallel and spaced apart sides, a front and a mutually parallel and spaced apart bottom, said front and said bottom being perpendicular to said sides, said case being generally hollow;
a lighting assembly upon said front and opposite said base, said lighting assembly including a transparent cover and at least two elements therein;
a processor within said case and in communication to said lighting assembly;
a radio antenna in communication with said processor;
a power source in communication with said processor; and,
is a transmitter capable of signaling said radio antenna.

2. The emergency indicating system of claim 1 wherein said power source is a utility service stepped down to approximately twelve volts direct current by a transformer, said transformer including a barrel socket upon wiring, said bottom including a socket wired to said processor, said socket receiving said barrel socket and communicating electrical power from said transformer to said processor.

3. The emergency indicating system of claim 1 further comprising:
said at least two elements being light emitting diodes of at least two colors.

4. The emergency indicating system of claim 3 further comprising:
one of said processor or said lighting assembly illuminating said at least two elements in an alternating manner.

5. The emergency indicating system of claim 2 wherein said lighting assembly includes six elements and said transparent cover has a Fresnel like lens outwardly of said elements wherein said elements emit light for at least one mile.

6. The emergency indicating system of claim 4 further comprising:
said transmitter including at least one button wherein upon depressing said at least one button, said transmitter emits a radio signal collected by said antenna and delivered to said processor, and said processor thus delivers electrical power to said lighting assembly.

7. The emergency indicating system of claim 1 wherein said power source is at least one battery.

8. A visible emergency indicating system installed upon an exterior surface of a residential structure, comprising:
a case having a base, a front opposite said base, two mutually parallel and spaced apart sides, a front and a mutually parallel and spaced apart bottom, said front and said bottom being perpendicular to said sides, said case being generally hollow;
a lighting assembly upon said front and opposite said base, said lighting assembly including a transparent cover and at least two elements therein, said transparent cover having a Fresnel like lens outwardly of said elements wherein said elements emit light for at least one mile;
a processor within said case and in communication to said lighting assembly, said processor illuminating said at least two elements in an alternating manner;
a radio antenna in communication with said processor;
a power source in communication with said processor, said power source being utility service stepped down by a transformer, said transformer including a barrel socket upon wiring, said bottom including a socket wired to said processor, said socket receiving said barrel socket and communicating electrical power from said transformer to said processor; and,
a transmitter capable of signaling said radio antenna, said transmitter including at least one button wherein upon depressing said at least one button, said transmitter emits a radio signal collected by said antenna and delivered to said processor, and said processor thus delivers electrical power to said lighting assembly.

9. A method of a user visibly indicating an emergency related to the user at a residential structure in a rural area to first responders at a distance of at least one mile comprising:
providing a device having intermittent illumination and activated by radio command from a separate hand held transmitter;
installing said device upon an exterior surface of a residence visible to the first responders and connecting said device to utility service of the residence;
triggering said device to illuminate upon a signal emitted by the transmitter upon the user pressing a button of the transmitter; and,
deactivating said device upon the user pressing another button of the transmitter.
